(19) United States
(12) Patent Application Publication
(10) Pub. No.: US 2025/0249576 A1
(43) Pub. Date: Aug. 7, 2025

(54) DETERMINATION DEVICE, PROCESSING SYSTEM, TRANSFER SYSTEM, DETERMINATION METHOD, AND STORAGE MEDIUM

(71) Applicant: KABUSHIKI KAISHA TOSHIBA, Tokyo (JP)

(72) Inventors: Kazuma KOMODA, Yokohama (JP); Junichiro OOGA, Kawasaki (JP); Ping JIANG, Kawasaki (JP); Haifeng HAN, Yokohama (JP)

(73) Assignee: KABUSHIKI KAISHA TOSHIBA, Tokyo (JP)

(21) Appl. No.: 19/048,201

(22) Filed: Feb. 7, 2025

(30) Foreign Application Priority Data
Feb. 7, 2024 (JP) 2024-017378

(51) Int. Cl. B25J 9/16; G06T 7/50; G06V 10/762; G06V 10/764

(52) U.S. Cl. CPC B25J 9/1612; G06T 7/50; G06V 10/762; G06V 10/764; G06T 2207/20081; G06T 2207/20084

(57) ABSTRACT

According to one embodiment, a determination device is configured to acquire an image of an object to be gripped and input the image to a determination part. The determination device is configured to obtain, from the determination part, an acquisition method of a gripping point. According to the input of the image, the determination part outputs, as the acquisition method, one of a first method, a second method, or a third method. The first method is a method of calculating exterior shape data of the object based on the image and calculating the gripping point by using the exterior shape data. The second method is a method of inputting the image to a second model and acquiring the gripping point output from the second model, the second model being trained. The third method is a method of acquiring the gripping point by the gripping point being designated.

### CROSS-REFERENCE TO RELATED APPLICATIONS

This application is based upon and claims the benefit of priority from Japanese Patent Application No. 2024-017378, filed on Feb. 7, 2024; the entire contents of which are incorporated herein by reference.

### FIELD

Embodiments of the invention generally relate to a determination device, a processing system, a transfer system, a determination method, and a storage medium.

### BACKGROUND

There is a device that grips and transfers objects. Technology that can increase the processing efficiency of the transfer device is desirable.

### BRIEF DESCRIPTION OF THE DRAWINGS

FIG. 1 is a schematic view showing a configuration of a processing system according to an embodiment;

FIG. 2 is a schematic view illustrating a specific configuration of the processing system;

FIG. 3 is a schematic view showing an example of a determination part;

FIG. 4 is a schematic view showing another example of the determination part;

FIGS. 5A and 5B are schematic views showing an example of the training method of the determination part;

FIG. 6 is a perspective view schematically illustrating the method for calculating the exterior shape data of an object;

FIG. 7 is a plan view schematically illustrating the method for calculating the exterior shape data of the object;

FIG. 8 is a schematic view for describing the distance data of the distance between the center of a contact surface and the centroid of the object;

FIG. 9 is a schematic view showing the state when a suction mechanism grips the object;

FIG. 10 is a schematic view showing the state when a pinching mechanism grips the object;

FIG. 11 is a schematic view illustrating a second model;

FIG. 12 is a schematic view showing an example of a graphical user interface;

FIGS. 13A and 13B are schematic views showing the examples of the graphical user interface;

FIG. 14 is a schematic view showing an example of a graphical user interface;

FIGS. 15A to 15C are schematic views showing the examples of the graphical user interface;

FIG. 16 is a flowchart illustrating a processing method according to the embodiment;

FIG. 17 is a flowchart showing a processing method according to a first modification of the embodiment;

FIG. 18 is a schematic view showing a configuration of a processing system according to a modification of the embodiment; and

FIG. 19 is a schematic view illustrating a hardware configuration.

### DETAILED DESCRIPTION

According to one embodiment, a determination device is configured to acquire an image of an object to be gripped. The determination device is configured to input the image to a determination part, the determination part including a first model, the first model being trained. The determination device is configured to obtain, from the determination part, an acquisition method of a gripping point at which a gripper is to grip the object. According to the input of the image, the determination part outputs, as the acquisition method, one of a first method, a second method, or a third method. The first method is a method of calculating exterior shape data of the object based on the image and calculating the gripping point by using the exterior shape data. The second method is a method of inputting the image to a second model and acquiring the gripping point output from the second model, the second model being trained. The third method is a method of acquiring the gripping point by the gripping point being designated.

Embodiments of the invention will now be described with reference to the drawings. The drawings are schematic or conceptual; and the relationships between the thicknesses and widths of portions, the proportions of sizes between portions, etc., are not necessarily the same as the actual values thereof. The dimensions and/or the proportions may be illustrated differently between the drawings, even in the case where the same portion is illustrated. In the drawings and the specification of the application, components similar to those described thereinabove are marked with like reference numerals, and a detailed description is omitted as appropriate.

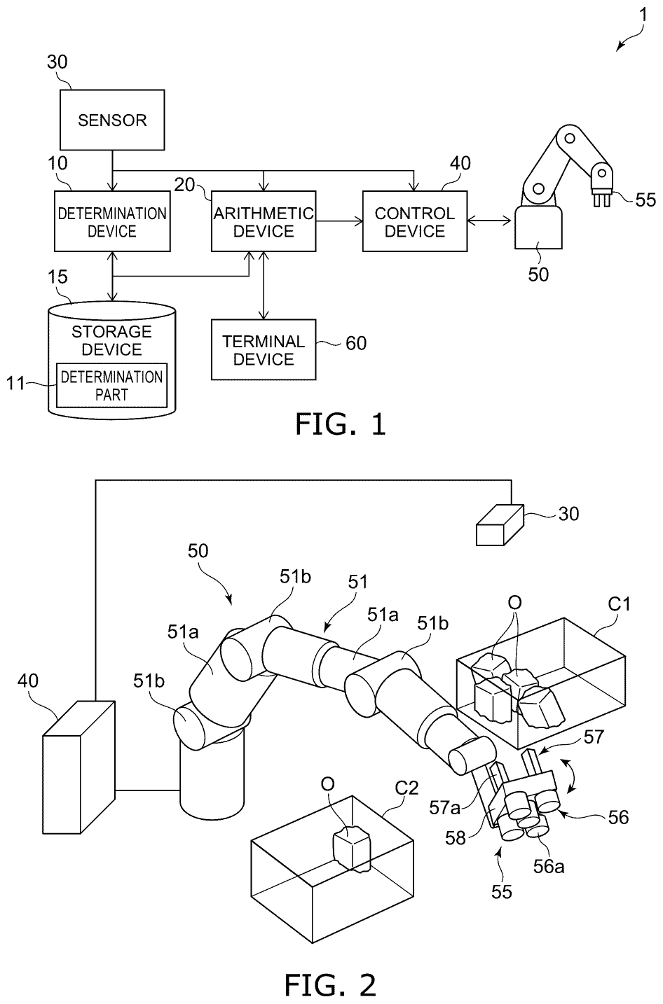

FIG. 1 is a schematic view showing a configuration of a processing system according to an embodiment.

The processing system 1 according to the embodiment includes a determination device 10, a storage device 15, an arithmetic device 20, a sensor 30, a control device 40, a transfer device 50, and a terminal device 60.

The transfer device 50 can handle and transfer an object. For example, the transfer device 50 grips an object stored in some container. The transfer device 50 lifts the gripped object and transfers the object to another container. The transfer device 50 releases the gripped object in the other container. The object is placed and stored in the container. Herein, a series of operations including gripping, transferring, and placing is called “picking”. For example, the transfer device 50 is a picking robot.

The transfer device 50 includes a gripper 55. The gripper 55 can grip an object by pinching, suction-gripping, jamming, etc. The gripper 55 may include both a mechanism for pinching and a mechanism for suction-gripping, and either mechanism may be selectively used.

The control device 40 controls the transfer device 50. The control device 40 is a so-called robot controller. The control device 40 moves the gripper 55 to a gripping point when the transfer device 50 grips the object. The “gripping point” is represented by the three-dimensional position (X, Y, Z) and the three-dimensional angle (ϕ, θ, ψ). The gripper 55 grips the object at the gripping point.

The sensor 30 detects the object to be gripped. For example, the sensor 30 is an image sensor. A camera that includes the sensor 30 is used. The camera acquires an image by imaging the object. The camera may acquire a video image. In such a case, a still image is cut out from the video image. The sensor 30 acquires an RGB image or a depth image. Favorably, both an RGB image and a depth image are acquired. A sensor 30 for acquiring an RGB image and another sensor 30 for acquiring a depth image may be used.

Or, the sensor 30 may be a distance sensor. For example, a laser rangefinder (LRF) that includes the sensor 30 is used. The LRF can acquire a range image by measuring the distances to objects in the surrounding area. Both a camera and a LRF may be used as the sensor 30.

The arithmetic device 20 acquires the gripping point at which the gripper 55 is to grip the object. The determination device 10 determines an acquisition method of the gripping point.

The arithmetic device 20 performs the acquisition method determined by the determination device 10. The storage device 15 stores data of the processing of the determination device 10 and the arithmetic device 20, data obtained by the processing, etc.

The determination device 10 uses a determination part 11 to determine the acquisition method. The determination part 11 includes a first model that is trained. The determination part 11 outputs the acquisition method of the gripping point according to the input of the image. The determination device 10 inputs, to the determination part 11, the image acquired by the sensor 30, and obtains the acquisition method output from the determination part 11. The determination part 11 outputs, as the acquisition method, one of a first method, a second method, or a third method. The arithmetic device 20 performs the one of the first method, the second method, or the third method.

In the first method, the arithmetic device 20 calculates exterior shape data of the exterior shape (the contour) of the object based on the image. The arithmetic device 20 generates a combination (a pattern) of the portion of the exterior shape to be gripped and the gripping point of the gripper 55. The arithmetic device 20 generates many patterns while changing the portion to be gripped, the position of the gripper 55, the posture of the gripper 55, etc. The arithmetic device 20 calculates the score of each pattern. The gripping point of the pattern for which the best score is obtained is employed as the gripping point to be actually used.

In the second method, the arithmetic device 20 inputs the image to a second model that is trained. The second model is machine-learned beforehand to calculate the gripping point according to the input of the image. The second model includes a neural network. The arithmetic device 20 acquires the gripping point output from the second model.

In the third method, the gripping point is designated by a person; and the arithmetic device 20 acquires the gripping point by the gripping point being designated. First, the arithmetic device 20 requests the terminal device 60 to designate the gripping point. Then, according to the request from the arithmetic device 20, the user of the terminal device 60 designates the gripping point. The terminal device 60 accepts the gripping point designated by the user and transmits the gripping point to the arithmetic device 20. The arithmetic device 20 acquires the gripping point transmitted from the terminal device 60.

When gripping one object, the arithmetic device 20 acquires the gripping point by performing only one of the first method, the second method, or the third method. When gripping the one object, the arithmetic device 20 does not perform the remaining two of the first method, the second method, or the third method.

The determination device 10, the storage device 15, the arithmetic device 20, and the sensor 30 are connected to each other via a network, wireless communication, or wired communication. One device may include the functions of both the determination device 10 and the arithmetic device 20. The control device 40 and the terminal device 60 each are connected with the arithmetic device 20 via a network, wireless communication, or wired communication.

The determination device 10 transmits the selected acquisition method to the arithmetic device 20. The sensor 30 transmits the acquired image to the arithmetic device 20. The arithmetic device 20 acquires the gripping point by using the received acquisition method. The arithmetic device 20 transmits the acquired gripping point to the control device 40. The control device 40 moves the gripper 55 to the received gripping point and causes the gripper 55 to grip the object at the gripping point. The transfer device 50 transfers the gripped object. The processing system 1 functions as a transfer system that transfers (handles) the object.

Inventions according to embodiments will now be described more specifically.

### Transfer Device

FIG. 2 is a schematic view illustrating a specific configuration of a processing system.

In the example shown in FIG. 2, the transfer device 50 is a vertical articulated robot. The transfer device 50 includes a manipulator 51 that includes multiple links 51a and multiple rotation axes 51b. The links 51a are coupled to each other by the rotation axes 51b.

The position and angle of the distal end of the manipulator 51 are changed by operating the rotation axes 51b. It is favorable for the distal end of the manipulator 51 to have six degrees of freedom. The gripper 55 is mounted to the distal end of the manipulator 51. In the illustrated example, the gripper 55 includes a suction mechanism 56 and a pinching mechanism 57.

The suction mechanism 56 grips the object by suction. The suction mechanism 56 includes one or more suction pads 56a. The interior of the suction pad 56a is decompressed by a depressurizing apparatus (not illustrated) in a state in which the suction pad 56a contacts the object. As a result, the object is suction-gripped by the suction pad 56a. The number of the suction pads 56a may be more or less than in the illustrated example.

The pinching mechanism 57 grips the object by pinching. The pinching mechanism 57 includes multiple rod-shaped support parts 57a. The object is pinched and gripped by the multiple support parts 57a. The pinching mechanism 57 may include more support parts 57a than in the illustrated example. The support part 57a may have a finger-like configuration including one or more joints.

The gripper 55 further includes a switching mechanism 58. The suction mechanism 56 and the pinching mechanism 57 are coupled to the switching mechanism 58. The switching mechanism 58 rotates the suction mechanism 56 and the pinching mechanism 57. The mechanism that is used to grip the object can be switched by rotating the suction mechanism 56 and the pinching mechanism 57.

The gripper 55 is not limited to the illustrated example, and may include only one of the suction mechanism 56 or the pinching mechanism 57. In such a case, the switching mechanism 58 is unnecessary.

Two containers C1 and C2 are placed proximate to the transfer device 50. The transfer device 50 grips an object O stored in the container C1 and transfers the object O to the container C2.

The sensor 30 is provided to detect the state inside the container C1. The object O stored in the container C1 is detected from above by the sensor 30. In addition to the sensor 30 for detecting the state inside the container C1, another sensor 30 for detecting the state inside the container C2 may be provided. The sensor 30 may be mounted to the transfer device 50.

Other than that of the illustrated example, the transfer device 50 may be a parallel link robot that includes the gripper 55. The transfer device 50 may be an aircraft (a drone or the like) that includes the gripper 55. Regardless of which transfer device 50 is used, the gripper 55 of the transfer device 50 grips the object at the gripping point acquired by the arithmetic device 20.

### First Model

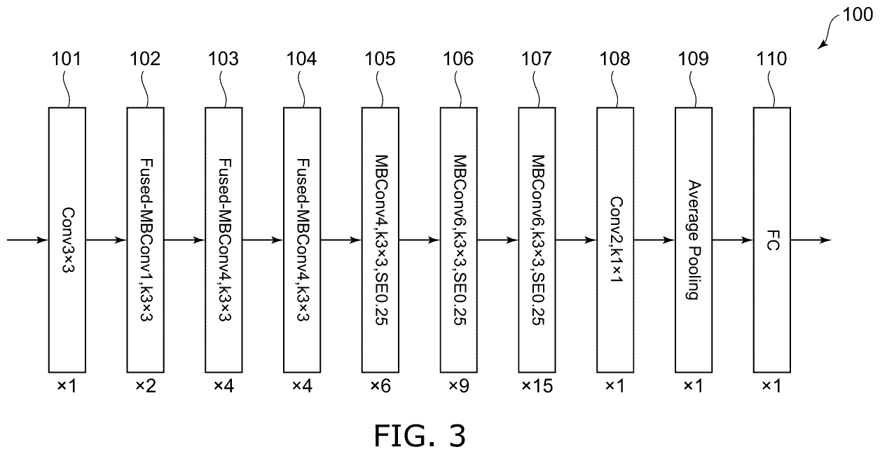

FIG. 3 is a schematic view showing an example of the determination part.

It is favorable for the first model of the determination part 11 to include a neural network. For example, the first model includes a convolutional neural network. FIG. 3 is an example of the first model that includes a convolutional neural network. In the example shown in FIG. 3, a convolutional neural network based on EfficientNetV2 is used.

Specifically, the first model 100 shown in FIG. 3 includes blocks 101 to 110. The numerical values below the blocks 101 to 110 show number of layers of each block. The blocks 101 to 108 convolve the data. The blocks 101 to 108 repeat the extraction of feature points from the image and compression of the extracted feature points. The block 109 uses pooling to further reduce the data compressed by the blocks 101 to 108. The block 110 fully connects the data output from the block 109.

For example, the block 110 outputs the probabilities of the first, second, and third methods. The probabilities respectively represent the possibilities that the object can be gripped when the methods are performed. The method having the highest probability is optimal as the acquisition method. The determination device 10 determines the acquisition method to be the method having the highest probability.

The first model is machine-learned beforehand. Supervised learning can be used in the machine learning. Multiple data sets are used in the supervised learning. Each data set includes training images and labels. The object to be gripped is visible in the training image. The label indicates the optimal method when gripping the object visible in the training image. One of the first method, the second method, or the third method is set as the label. The first model is trained repeatedly to output the method set by the label according to the input of the training image.

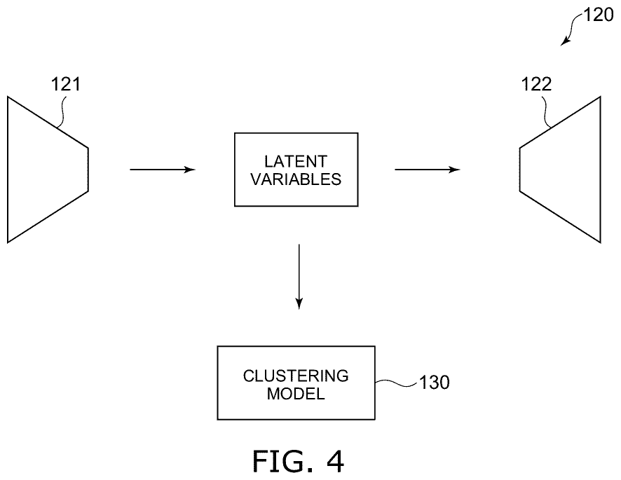

FIG. 4 is a schematic view showing another example of the determination part.

As shown in FIG. 4, the first model of the determination part 11 may include a variational auto encoder (VAE) 120 and a clustering model 130. The VAE 120 includes an encoder 121 and a decoder 122. When an image is input to the VAE 120, the encoder 121 dimensionally compresses the image into one or more latent variables. The latent variables are derived from the input data and are features of the input data. The decoder 122 reconstructs the original image from the one or more latent variables. The determination device 10 inputs the image to the VAE 120, acquires the one or more latent variables output from the encoder 121. The determination device 10 inputs the one or more latent variables to the clustering model 130. The determination device 10 may extract a part of latent variables and input those latent variables to the clustering model 130. The clustering model 130 is machine-learned beforehand to cluster the latent variables. The clustering model 130 clusters the input latent variables into one of a first cluster, a second cluster, and a third cluster. The first cluster corresponds to the first method. The second cluster corresponds to the second method. The third cluster corresponds to the third method.

The encoder 121 may output a probability distribution from the input image. The determination device 10 may input the probability distribution to the clustering model 130 to classify the input image into one of the first to third clusters.

As a specific example, the output of the encoder 121 may include a two-dimensional map of the latent variables for three methods. One of the three methods can be determined using a method that combines the k-means method with semi-supervised learning. For example, classification can be performed by setting the centroid of latent variables as labeled data and then determining the clusters of each point. When training a model, VAE is learned at first, and then the result is used to perform semi-supervised learning with k-means.

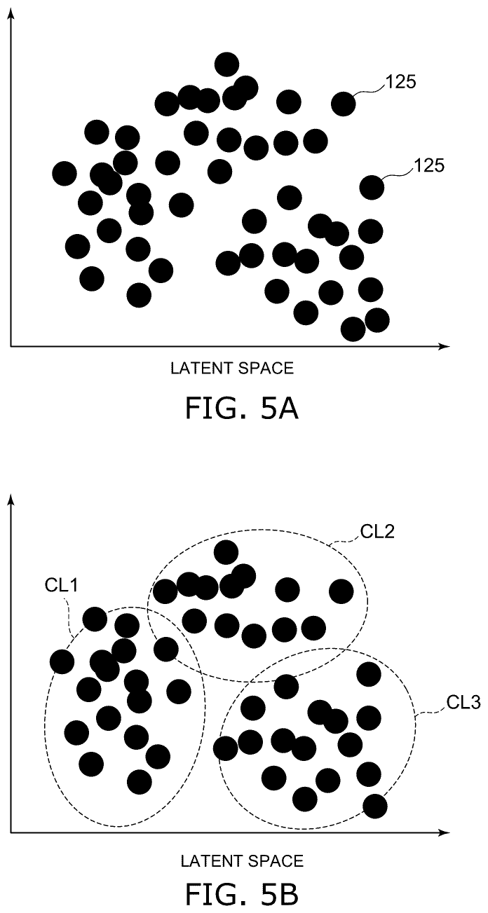

FIGS. 5A and 5B are schematic views showing an example of the training method of the determination part.

Multiple training images are used to train the VAE 120. The object to be gripped is visible in each training image. The VAE 120 is trained to output the same image as the input training image. After the VAE 120 is trained, multiple training images are sequentially input to the VAE 120. Each time the training image is input to the VAE 120, the latent variable that is output from the encoder 121 is acquired. As shown in FIG. 5A, multiple latent variables 125 are obtained thereby. The clustering model 130 clusters the multiple latent variables 125. Unsupervised learning such as the k-means algorithm or the like is used for the clustering. The number of clusters is set to the three clusters of the cluster of the first method, the cluster of the second method, and the cluster of the third method. By the clustering as shown in FIG. 5B, the multiple latent variables 125 are clustered into the three clusters of a cluster CL1 of the first method, a cluster CL2 of the second method, and a cluster CL3 of the third method.

Or, the determination part 11 may include a classification model outputting the probabilities of the first, second, and third methods according to the input of the latent variables 125. In such a case, the classification model is machine-learned beforehand by supervised learning. When supervised learning is performed, multiple data sets are used similarly to the training of the first model 100 described above. Each data set includes the latent variables based on the input of the image and labels. One of the first method, the second method, or the third method is set as the label. The classification model is trained repeatedly to output the method set by the label according to the input of the latent variable.

### First Method

In the first method, the safety factor at each gripping point is estimated while thoroughly searching through multiple gripping points. The safety factor indicates the possibility that the object O can be transferred without dropping the object O, and corresponds to the score described above. The gripping point for which the highest safety factor is obtained is selected from the multiple gripping points.

An example of the method for calculating the safety factor when the suction mechanism 56 is used will now be described. The arithmetic device 20 acquires the data detected by the sensor 30 and recognizes the state of various components related to the control of the transfer device 50. For example, the arithmetic device 20 performs the prescribed image processing on the image to calculate “object exterior shape data”, “object centroid data”, etc., to indicate the state of the various components.

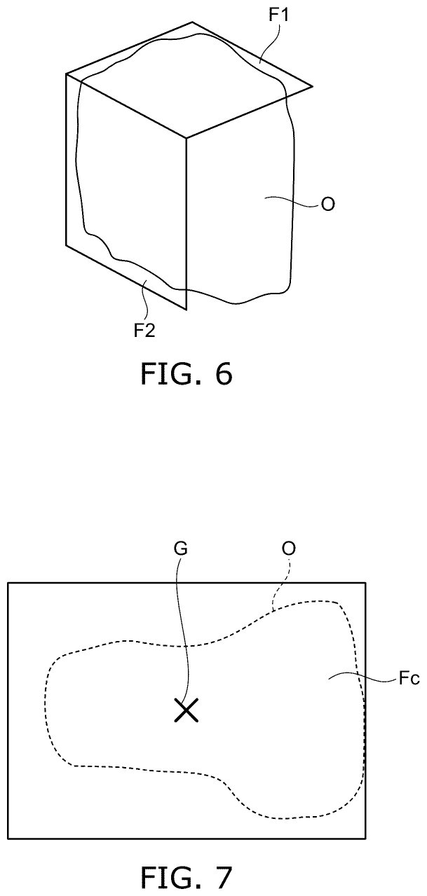

FIG. 6 is a perspective view schematically illustrating the method for calculating the exterior shape data of the object. FIG. 7 is a plan view schematically illustrating the method for calculating the exterior shape data of the object.

The “object exterior shape data” is calculated using the image of the object O. The object exterior shape data indicates the exterior shape of the object O stored in the container C1 from which the object O will be extracted. For example, as shown in FIG. 6, the object exterior shape data includes data related to a first surface F1 and a second surface F2 of a rectangular parallelepiped shape circumscribing the object O. The second surface F2 is adjacent to the first surface F1. When an object surface is not planar (when the object surface includes an unevenness), the arithmetic device 20 recognizes the rectangular parallelepiped shape circumscribing the object surface as the object exterior shape data as shown in FIG. 7. The arithmetic device 20 recognizes the exterior shape when the object is viewed along a specific direction as a holdable region Fc of the object. The holdable region Fc is a planar portion of the object surface that can be suction-gripped.

The arithmetic device 20 calculates the safety factor based on the contact area data and the distance data. The contact area data indicates the area where the gripper 55 and the holdable region of the object O contact. The distance data indicates a distance L between a center K of the contact surface and a centroid G of the object O. The contact surface is the surface where the gripper 55 and the object O contact.

The pressure at which the contact surface can be suction-gripped is called the “suction-grip pressure”. The stress, i.e., the distance L divided by a second area moment I having the contact surface as the cross section, is called the “divided stress value”. The arithmetic device 20 calculates a safety factor R based on the numerical value of the suction-grip pressure divided by the divided stress value. The safety factor R is the value of the suction-grip pressure at the gripping point divided by the sum of the bending stress and other tensile stress generated. The bending stress is calculated by the following Formula (1).

$$σ ( x ) = M \frac{x}{I} \qquad [ Formula 1 ]$$

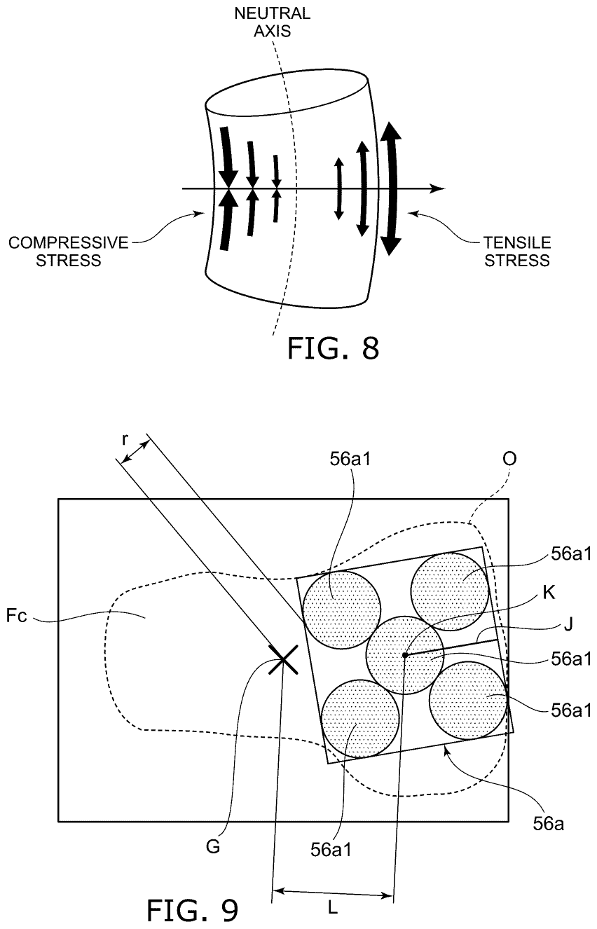

FIG. 8 is a schematic view for describing the distance data of the distance between the center of the contact surface and the centroid of the object. FIG. 9 is a schematic view showing the state when the suction mechanism grips the object.

In Formula (1), σ(x) is the bending stress, M is the moment, I is the second area moment, and x is the distance from the neutral axis. FIG. 8 shows a model when bending stress acts on a structure body. As shown in FIG. 8, tensile stress and compressive stress are generated in a structure body when bending stress acts on the structure body.

When bending stress acts on a structure body, the structure body fractures when the maximum bending stress is greater than the tensile stress that the structure body can withstand. In the case of suction-gripping, it can be considered that the suction pad 56a will detach from the object O being suction-gripped when the maximum bending stress exceeds the vacuum pressure for each suction pad 56a. The safety factor R is calculated by the following Formula (2).

$$R = \frac{P}{σ + {T}_{S}} \qquad [ Formula 2 ]$$

In Formula (2), P is the vacuum pressure (the suction-grip pressure) of any holding method, o is the bending stress, and Ts is the other tensile stress generated. According to the embodiment, the other tensile stress generated is taken as Ts. The safety factor R is the value of the suction-grip pressure at the gripping point divided by the bending stress. By omitting the tensile stress Ts, the safety factor R is calculated by the following Formula (3).

$$R = \frac{P}{M \times \frac{r}{I}} \qquad [ Formula 3 ]$$

In Formula (3), M is the moment determined by the distance L between the center K and the object centroid G. r is the shortest distance between the gripping surface contour and the object centroid G. I is the second area moment determined by any holding method. The example of FIG. 9 shows a case where the object centroid G is positioned outside the gripping surface. In such a case, the shortest distance r is the spacing between the object centroid G and the contour of an effective suction pad 56a1 most proximate to the object centroid G. The effective suction pads 56a1 refer to the suction pads 56a among the multiple suction pads 56a that are used to hold the object O. The contour of the effective suction pad 56a1 most proximate to the object centroid G is where the gripping surface detaches most easily.

As described above, to calculate the safety factor R, it is necessary to calculate the second area moment I. When the gripper 55 includes the multiple suction pads 56a, the number of combinations of the effective suction pads 56a1 used to grip is determined according to the number of the suction pads 56a for which the internal pressure is independently controllable. A number Q of combinations of the effective suction pads 56a1 used to grip is calculated by the following Formula (4), wherein the number of the suction pads 56a for which the internal pressure is independently controllable is N. For example, the number Q is 31 when the internal pressure is independently controllable for each of five suction pads 56a.

$$Q = {\sum }_{i = 1}^{i = N} {}_{N} {C}_{i} \qquad [ Formula 4 ]$$

The arrangement directions of the suction pads 56a are taken as a first arrangement direction and a second arrangement direction. The first arrangement direction and the second arrangement direction cross each other. The arithmetic device 20 calculates the second area moment I around the first and second arrangement directions while rotating the group of effective suction pads 56a1 180 degrees along a plane parallel to the first and second arrangement directions, 1 degree at a time. The arithmetic device 20 performs the calculation for all combinations.

The arithmetic device 20 calculates the safety factor R described above for each second moment I obtained. For example, when the number Q is 31, there are 31×181=5611 patterns of combinations of the effective suction pads 56a1 and angles of the suction mechanism 56. The arithmetic device 20 calculates the second moment I and the safety factor R for each pattern. The arithmetic device 20 selects the pattern for which the highest safety factor R is obtained as the gripping point actually used in the gripping.

Specific methods for calculating the safety factor when using the suction mechanism 56 are discussed, for example, in paragraphs 0061 to 0096 of JP-A 2021-037608 (Kokai), etc.

An example of a method for calculating the safety factor when the pinching mechanism 57 is used will now be described. Here, a method for calculating the safety factor when two support parts 57a hold the object O will be described. When the pinching mechanism 57 includes three or more support parts 57a, the arithmetic device 20 can calculate the safety factor by approximating the holding state of the object O as a state in which two support parts 57a hold the object O.

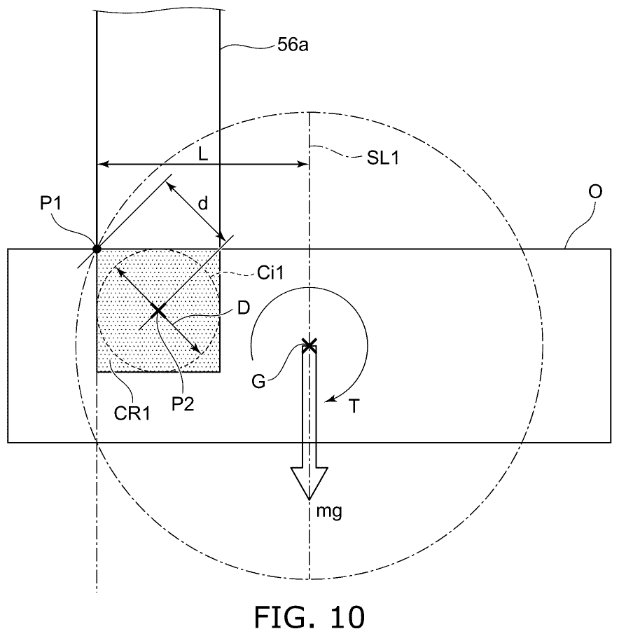

FIG. 10 is a schematic view showing the state when the pinching mechanism grips the object.

The arithmetic device 20 calculates the safety factor by using multiple parameters. The multiple parameters include at least a diameter D, a distance d, a length L, and a gravitational force mg. The diameter D is a parameter related to the size of the region where the support part 57a and the object O contact. Hereinbelow, this region is called a contact region CR1. The diameter D is the diameter of a circle Ci1 inscribing the contour of the contact region CR1. In the example, the shape of the contact region CR1 is approximated as the circle Ci1. In such a case, the area of the contact region CR1 is estimated to be smaller, and so the arithmetic device 20 can calculate the safety factor with greater consideration of the likelihood of dropping the object O.

The distance d is a parameter related to a position P1 at which the maximum bending stress (torsional stress) is generated in the contact region CR1. The position P1 is the point of the contour of the contact region CR1 most distant to the object centroid G. The distance d is the distance between the position P1 and a center position P2 of the contact region CR1.

The length L is a parameter related to the bending moment (torsional moment) generating bending stress in the contact region CR1. The length L is the length of the arm at which the bending moment is generated. The length L is the distance between the position P1 and a straight line SL1 passing through the object centroid G in the vertical direction. The gravitational force mg is a parameter related to the weight of the object O. The gravitational force mg is the product of a mass m of the object O and a magnitude g of the acceleration due to gravity. A torque T, which is the bending moment generated at the position P1, is represented by the following Formula (5).

$$T = Lmg \qquad [ Formula 5 ]$$

A second area polar moment Ip of the circle Ci1, i.e., the approximate shape of the contact region CR1, is represented by the following Formula (6).

$$Ip = \frac{π {D}^{4}}{32} \qquad [ Formula 6 ]$$

Bending stress t generated by the torque T is represented by the following Formula (7).

$$τ = \frac{Td}{2 Ip} \qquad [ Formula 7 ]$$

Friction pressure Fp generated in the contact region CR1 is represented by the following Formula (8).

$$Fp = \frac{2 μ f}{A} \qquad [ Formula 8 ]$$

In Formula (8), a parameter f is the holding force of the support part 57a, a parameter μ is the friction coefficient corresponding to the object O, and a parameter A is the area of the contact region CR1. The friction pressure Fp is generated in all directions inside the contact region CR1. The safety factor R is represented by the following Formula (9).

$$R = \frac{Fp}{τ} \qquad [ Formula 9 ]$$

When considering the vertically downward stress, the safety factor R is represented by the following Formula (10).

$$R = \frac{Fp}{τ + mg} \qquad [ Formula 10 ]$$

The arithmetic device 20 calculates the diameter D, the distance d, and the length L based on the object exterior shape data and the object centroid data. The arithmetic device 20 acquires mass data of the mass m of the object O from the storage device 15. The arithmetic device 20 calculates the safety factor R according to the formula above.

The arithmetic device 20 repeatedly calculates the safety factor while modifying the value of at least one of the multiple parameters. Multiple safety factors that correspond respectively to multiple states are calculated thereby. The arithmetic device 20 selects the state in which the highest safety factor is obtained as the gripping point.

Specific methods for calculating the safety factor when the pinching mechanism 57 is used are discussed in, for example, paragraphs 0052 to 0107 of JP-A 2021-146434 (Kokai), etc.

### Second Method

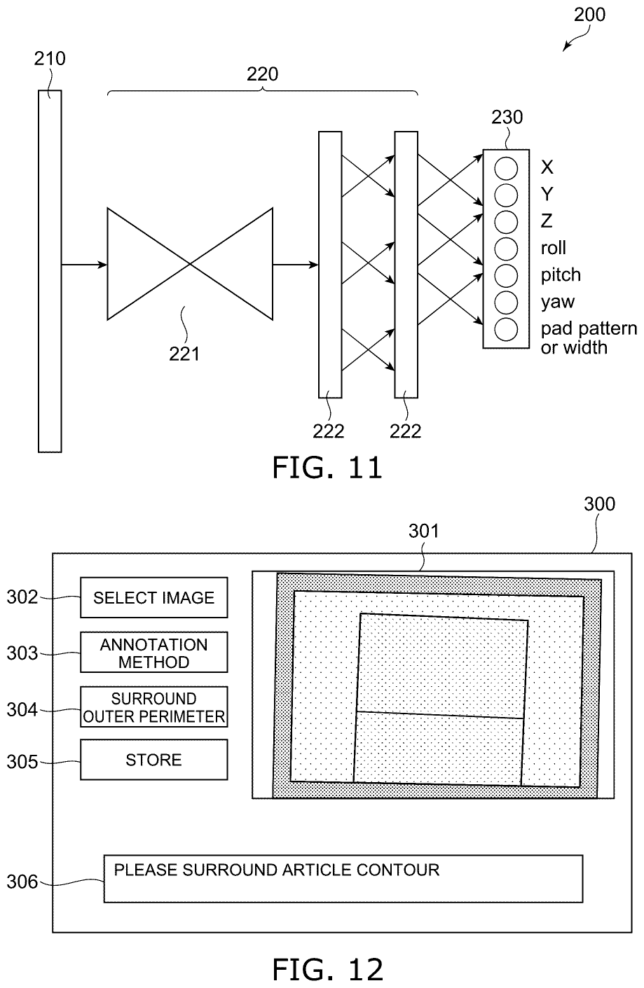

FIG. 11 is a schematic view illustrating the second model. The second model that is used in the second method is machine-learned beforehand. The second model includes a neural network. To obtain better gripping points, it is favorable for the neural network to be a convolutional neural network (CNN) that includes convolutional layers.

The second model 200 shown in FIG. 11 includes an input layer 210, intermediate layers 220, and an output layer 230. The image of the object is input to the input layer 210. The intermediate layers 220 include convolutional layers. In the illustrated example, the intermediate layers 220 include a ResNet 221 and a fully convolutional network (FCN) 222. The output layer 230 outputs the position (X, Y, Z) and the angle (ϕ, θ, ψ).

In the example shown in FIG. 11, the output layer 230 also outputs the gripping method. Specifically, when the object is gripped by the suction mechanism 56, the output layer 230 outputs the combination (the pad pattern) of the suction pads 56a utilized to grip the object. When the object is gripped by the pinching mechanism 57, the output layer 230 outputs the spacing (the width) between the support parts 57a.

The second model 200 is machine-learned using multiple sets of training data. Each set of training data includes a combination of the input image and teaching data. The teaching data indicates the gripping point at which the object visible in the input image can be safely gripped, the combination of the suction pads 56a (or the spacing between the support parts 57a), etc. The intermediate layers 220 are trained to output the teaching data for the input image.

Or, multiple models may be used as the second model. For example, a first submodel and a second submodel are used as the second model. The first submodel outputs, according to the input of the image, the position of the gripper 55 when the object is gripped. The second submodel outputs, according to the input of the image and the position output from the first submodel, the angle of the gripper 55 when the object is gripped.

### Third Method

FIGS. 12, 13A, 13B, 14, and 15A to 15C are schematic views showing examples of graphical user interfaces.

When the third method is performed, the arithmetic device 20 requests the terminal device 60 to designate the gripping point. The terminal device 60 displays a graphical user interface (GUI) for the user to designate the gripping point. For example, the terminal device 60 displays a GUI for designating the position of the object, and a GUI for designating the position and angle of the gripper 55.

The GUI 300 shown in FIG. 12 is displayed for designating the position of the object. The GUI 300 includes an image 301, icons 302 to 305, and a message window 306. The image that is acquired by the sensor 30 is displayed in the image 301. The icon 302 is displayed for selecting the image displayed in the image 301. For example, the sensor 30 repeatedly and continuously acquires images. By clicking the icon 302, the user can select the image to be displayed in the image 301 from the multiple images acquired by the sensor 30.

The icon 303 is displayed for selecting the annotation method of the area of the object in the image displayed in the image 301. The icon 304 is clicked when designating the outer perimeter of the object for the image displayed in the image 301. The icon 305 is clicked when storing the position of the object that is taught. The message window 306 provides instructions to the user. The user inputs operations in the GUI 310 according to the instructions displayed in the message window 306.

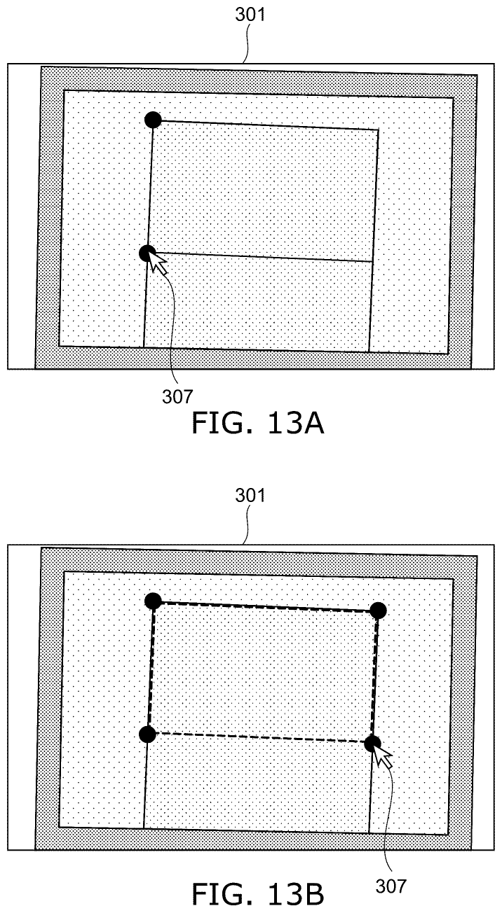

For the icon 303, annotation methods include manual annotation, annotation by image processing, and annotation by a combination of manual and image processing. The user can select which method to use by clicking the icon 303. When manually annotating, the user sequentially designates the vertices of the object by operating a pointer 307 as shown in FIG. 13A. The user clicks the icon 304 after designating all of the vertices. As shown in FIG. 13B, a line segment that connects the designated vertices to each other is used as the outer perimeter of the object; and the region inside the outer perimeter is surrounded. The region that is surrounded with the outer perimeter is taught as the position (the area) of the object.

When annotation by image processing is selected, the terminal device 60 detects objects based on the image and displays the detected area of each object. For example, edge detection is used to detect the object. The Canny method, the keypoint matching method, or the like can be used for the edge detection. When annotation by a combination of manual and image processing is selected, first, the terminal device 60 uses image processing to detect the object. The terminal device 60 displays the vertices of the detected object. The user clicks the icon 304 after using the pointer 307 to adjust the positions of the vertices. As a result, the line segment that connects the designated vertices to each other is used as the outer perimeter of the object.

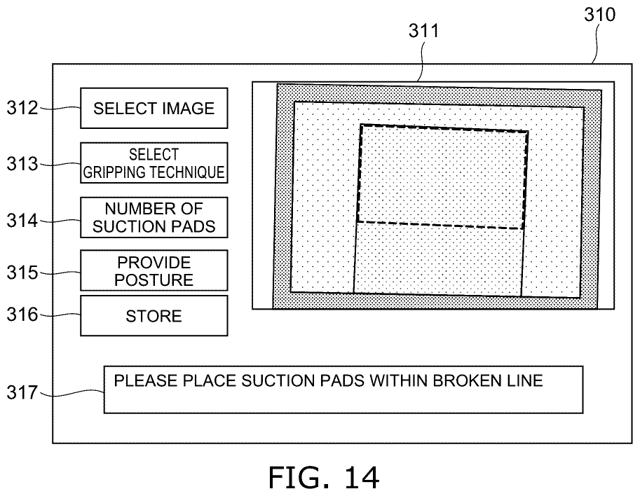

The GUI 310 shown in FIG. 14 is displayed for designating the position and angle of the gripper 55. The GUI 310 includes an image 311, icons 312 to 316, and a message window 317. The image that is acquired by the sensor 30 is displayed in the image 311. Also, the position of the object taught in the GUI 300 is illustrated by a broken line in the image 311. The icon 312 is displayed for selecting the image displayed in the image 311. The icon 313 is clicked when selecting the gripping technique of the object. When the transfer device 50 shown in FIG. 2 is used, the gripper 55 includes the two gripping techniques of suction-gripping and pinching. By clicking the icon 313, the user can select which gripping technique is to be used from suction-gripping and pinching. The display of the icon 313 may be omitted when the gripper 55 includes only one gripping technique.

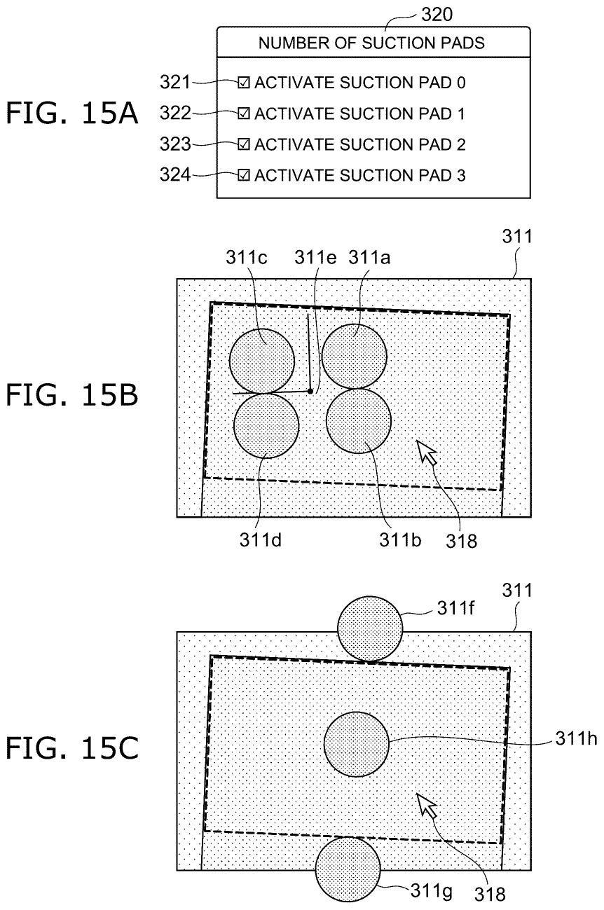

The icon 314 is displayed for selecting the number of suction pads used to grip when suction-gripping is used as the gripping technique. When the icon 314 is clicked, a window 320 shown in FIG. 15A is displayed. FIG. 15A shows an example when the gripper 55 includes four suction pads. The gripper 55 includes suction pads 0 to 3. The user can designate which suction pads are to be used to grip by appropriately checking checkboxes 321 to 324 of the window 320.

When the user has checked one or more of the checkboxes 321 to 324, suction pads 311a to 311d and a center point 311e of the suction pads 311a to 311d are displayed on the image 311 of the GUI 310 as shown in FIG. 15B. By clicking the icon 315, the user can adjust the position and angle of the displayed suction pads 311a to 311d. For example, the user can translate the suction pads 311a to 311d by operating a pointer 318 to drag & drop the center point 311e. Also, the user can rotate the suction pads 311a to 311d around the center point 311e by dragging & dropping any of the suction pads 311a to 311d.

When the number, position, and angle of the suction pads are finalized, the user clicks the icon 316. As a result, the number, position, and angle of the suction pads designated by the user are stored.

When pinching is selected as the gripping technique, the user designates the positions of the support parts of the pinching mechanism. FIG. 15C shows an example when the pinching mechanism includes two support parts. The user designates the position and angle of each support part in the image 311. For example, the user can place support parts 311f and 311g as shown in FIG. 15C by clicking the pointer 318 on the image 311. The user clicks the icon 316 when the support parts 311f and 311g are placed. The support part 311f and the support part 311g are stored as the positions of the support parts. A midpoint 311h between the support part 311f and the support part 311g is stored as a pinching point. The angle of a line segment from the support part 311f to the support part 311g with respect to the horizontal axes of the image coordinate system is stored as the rotation angle of the pinching mechanism.

The message window 317 shows an instruction to the user. The user inputs operations on the GUI 310 according to the instruction displayed in the message window 317.

The gripping point is derived when the GUI 310 has been used to designate the positions of the suction pads in the suction-gripping or the positions of the support parts in the pinching. The angle of the gripping point is represented by a normal vector of the surface contacted by the suction pads or the surface contacted by the midpoint between the support parts. The tilt of the surface contacted by the suction pads or the surface contacted by the midpoint between the support parts is calculated based on the image. To increase the accuracy of the tilt, it is favorable for the sensor 30 to be able to acquire a depth image.

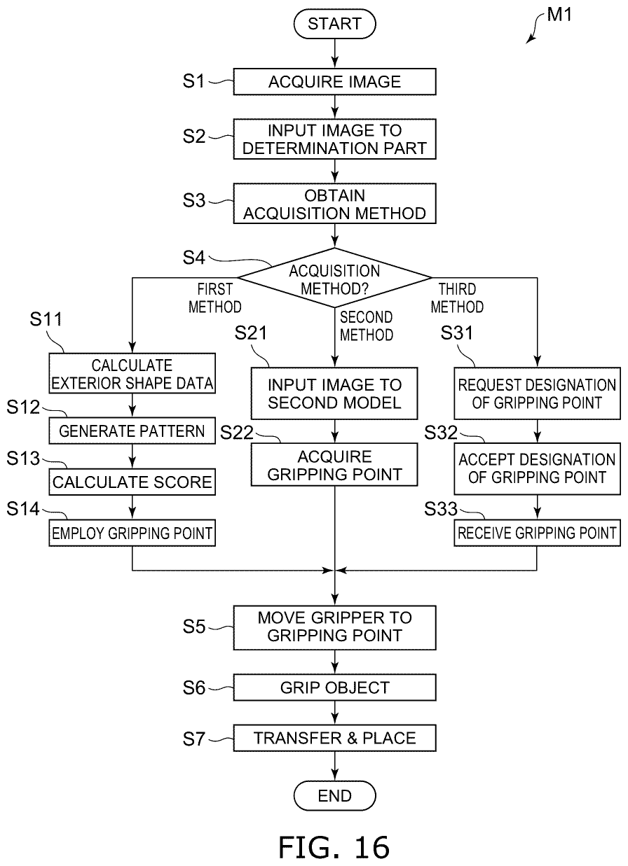

FIG. 16 is a flowchart illustrating a processing method according to the embodiment.

In a processing method M1 shown in FIG. 16, first, the processing system 1 receives an instruction from the higher-level system of the object to be gripped. When the container in which the object is stored is transferred according to the instruction, the sensor 30 acquires an image of the object to be gripped (step S1). The determination device 10 inputs the acquired image to the determination part 11 (step S2). The determination part 11 outputs the acquisition method of the gripping point according to the input of the image. The determination device 10 obtains the acquisition method output from the determination part (step S3). The arithmetic device 20 determines the acquisition method output from the determination device 10 to be one of the first to third methods (step S4).

When the acquisition method is the first method, the arithmetic device 20 calculates exterior shape data representing the exterior shape of the object based on the image (step S11).

The arithmetic device 20 generates multiple combinations (patterns) of the portion to be gripped and the gripping point of the gripper 55 (step S12). The arithmetic device 20 calculates the score of each pattern (step S13). The arithmetic device 20 employs, as the gripping point to be actually used, the gripping point of the pattern for which the best score is obtained (step S14).

When the acquisition method is the second method, the arithmetic device 20 inputs the image to the second model (step S21). The arithmetic device 20 acquires the gripping point output from the second model (step S22).

When the acquisition method is the third method, the arithmetic device 20 requests the terminal device 60 to designate the gripping point (step S31). The terminal device 60 accepts the designation of the gripping point by the user (step S32). The arithmetic device 20 receives the gripping point from the terminal device 60 (step S33).

The control device 40 moves the gripper 55 to the gripping point acquired by one of the methods (step S5). The control device 40 causes the gripper 55 to grip the object at the gripping point (step S6). The control device 40 causes the gripper 55 to transfer and place the object in another container (step S7).

Advantages of the embodiment will now be described.

The gripping point is determined when a transfer device grips an object. The gripping point is represented by a three-dimensional position and a three-dimensional angle. The first method and the second method described above may be considered as methods to obtain the gripping point. In the first method, the exterior shape data of the object is calculated; and various parameters such as the centroid, etc., are calculated using the exterior shape data. The gripping point is calculated using the parameters. In the second method, the second model outputs the gripping point. As a result, it is unnecessary to calculate the exterior shape data, calculate various parameters based on the exterior shape data, etc. According to the first method, compared to the second method, a gripping point at which the object can be more stably gripped can be calculated. According to the second method, compared to the first method, the gripping point can be obtained more quickly.

When only the first method is used to acquire the gripping point, more objects can be more stably gripped. As a result, errors such as gripping failures, the object being dropped during transfer, etc., can be suppressed.

When only the second method is used to acquire the gripping point, the gripping point is obtained more quickly. As a result, the standby time of the transfer device 50 before the gripping operation can be reduced. For example, the standby of the transfer device 50 due to the acquisition of the gripping point can be avoided. As a result, the number of objects that can be gripped and transferred per unit time can be increased. The processing efficiency of the transfer can be further increased.

By combining the first method and the second method, the advantages of each method can be taken advantage of. According to the first method, an appropriate gripping point is easily obtained even when the object that is visible in the image has not yet been trained, when the object is difficult to recognize in the image, etc. As a result, the occurrence of gripping failures, the object being dropped due to unstable gripping, etc., can be suppressed. According to the second method, exterior shape data and the calculation of parameters and the like based on the exterior shape data are unnecessary, and the time necessary for the calculation can be reduced. In other words, when the appropriate gripping point can be acquired by the second method, the gripping point can be more quickly obtained by performing the second method. For example, when it is difficult for the second method to obtain the gripping point, errors such as gripping failures, etc., can be suppressed by performing the first method. As a result, the object can be more stably gripped while increasing the processing efficiency.

The transfer efficiency is dependent on the time necessary for transferring the object. The time necessary for transferring the object includes the calculation time of the operation of the transfer device 50 by the control device 40, the operating time of the transfer device 50, the retry time when gripping fails, etc. When the calculation time by the control device 40 is long, it is necessary for the transfer device 50 to standby until the calculation ends. On this point, the calculation time can be reduced by obtaining the gripping point by using the second method. Also, gripping failures can be suppressed by using the first method to appropriately acquired the gripping point.

The inventor obtained the following knowledge by further examining the combination of the first and second methods. First, according to the combination of the first and second methods, the transfer efficiency can be effectively improved by reducing the average calculation time and reducing the gripping failure probability. It was found that, for the combination of the first and second methods, long retry times were occurring for the transfer of some objects; and such retry times reduced the transfer efficiency. For example, gripping failures easily occur for objects that deform easily when gripped, transparent objects, objects that easily reflect light, etc. Even when the first method is used, the gripping success rate is not high enough for the gripping points for such objects. It was found that in a retry operation when the gripping of such an object had failed, the gripping failure would occur again, and the retry time was greatly increased. It was found that a long retry time also occurred when unexpected trouble occurred when implementing the transfer processing; and such retry time also reduced the transfer efficiency.

In consideration of the problems described above, the inventor devised the use of the third method in addition to the first and second methods. In the third method, the gripping point is designated by a person. When a person designates the gripping point, an appropriate gripping point can be designated even for objects that deform easily, transparent objects, and objects that easily reflect light. Even when unexpected trouble occurs, a person can perform a more appropriate countermeasure. As a result, the gripping failure probability can be reduced. When the gripping point is designated by a person, the operating time of the person is necessary in addition to the calculation time of the control device 40. However, even when the operating time of the person is added, it was found that the transfer efficiency can be consequently increased because the occurrence of a retry operation, the repetition of retry operations, etc., can be suppressed.

According to the embodiment, the method among the first, second, and third methods to be used is output by the determination part 11. Accordingly, the time necessary for determining the acquisition method of the gripping point can be reduced, and the transfer efficiency can be further increased.

### First Modification

The determination device 10 may determine the state of the object based on the image together with the determination of the acquisition method of the gripping point. The state of the object is classified as one of normal without damage or abnormal with damage. “Damage” is a scratch, chipping, cracking, a sharp bend, tearing, etc. The determination device 10 inputs the image to a determination part for determining the state of the object. The determination device 10 acquires the state output from the determination part.

For example, a determination part for determining the state of the object may be provided separately from the determination part 11. Favorably, the determination part 11 includes the function as the determination part for determining the state of the object. By determining both the acquisition method of the gripping point and the state of the object, the time necessary for the determination of the determination part 11 can be less than when the acquisition method of the gripping point and the state of the object are determined by separate determination parts.

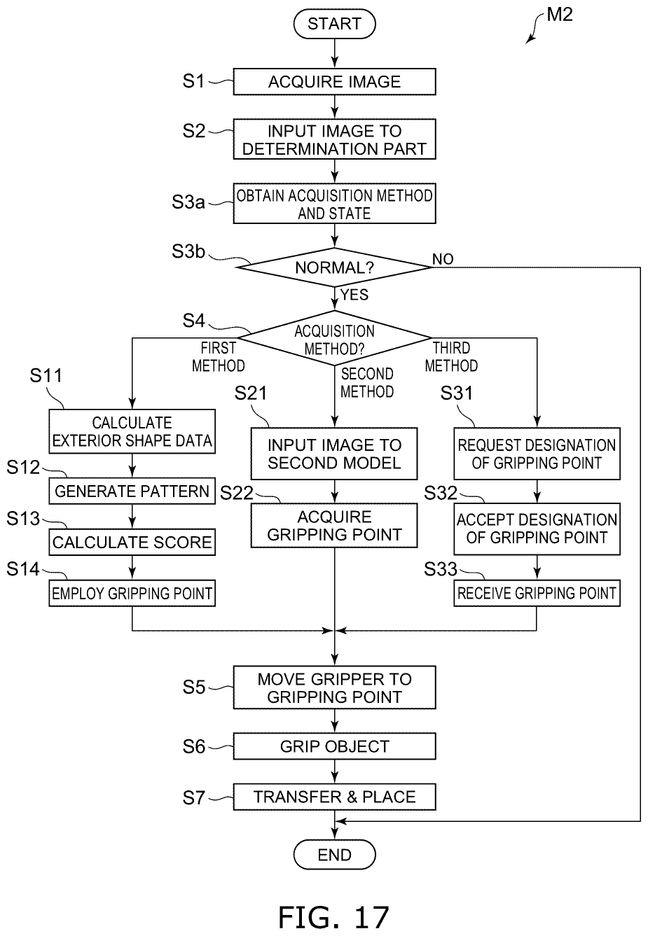

FIG. 17 is a flowchart showing a processing method according to a first modification of the embodiment.

Compared to the processing method shown in FIG. 16, a processing method M2 shown in FIG. 17 includes steps S3a and S3b instead of step S3. Here, an example will be described in which the determination part 11 outputs both the acquisition method and the state of the object. In step S3a, the determination device 10 acquires the acquisition method and the state of the object output from the determination part 11. In step S3b, the determination device 10 determines whether or not the state of the object is normal. When the state of the object is abnormal, the object is not gripped, and the processing ends. When the state of the object is normal, step S4 is performed similarly to the processing method M1. When the object is determined to be abnormal due to damage, another object of the same type is prepared. The processing method M2 is re-performed on the other object.

For example, the object that is transferred by the transfer device 50 is subsequently shipped. The object that is shipped must be normal and not damaged. To ship normal objects, a method may be considered in which the object is gripped by the transfer device 50, transferred, and then inspected to determine whether or not the transferred object is normal. However, according to such a method, the object is transferred and then inspected, and so if the object is abnormal, it is then necessary to transfer a normal object. In other words, two or more transfer operations are necessary for one object.

According to the processing method M2, the state of the object is determined before gripping. When the object is determined to be abnormal, the gripping is not performed. Accordingly, the likelihood of an abnormal object being gripped and transferred can be reduced. The number of repetitions of the transfer operation due to an abnormal object can be suppressed, and the processing efficiency of the transfer device 50 can be increased.

To determine the state of the object, it is favorable to use the image used to acquire the gripping point. The image that is obtained by the sensor 30 may include noise. For example, noise such as a disturbance, blurriness, whiteout, blackout, etc., of the image may be generated by the object reflecting light when the lighting conditions of the object are inappropriate, by effects of the texture of the object surface, etc. There is a possibility that the gripping success rate may be reduced when an image with much noise is used to acquire the gripping point. For this problem, it is effective to use the image used to acquire the gripping point in the determination of the state of the object. According to such a method, the object that is visible in the image can be determined to be abnormal when the noise included in the image affects the gripping success rate. In other words, it can be determined whether or not the object visible in the image is abnormal in addition to whether or not the object is actually abnormal. By determining the object visible in the image to be abnormal when the noise included in the image affects the gripping success rate, the occurrence of gripping failures can be suppressed. As a result, the processing efficiency of the transfer device 50 can be further increased. The image that is used to acquire the gripping point and the image that is used to determine the state of the object may not be exactly the same. For example, the images can be considered to be substantially the same when the imaging conditions of the image used to acquire the gripping point and the imaging conditions of the image used to determine the state of the object are substantially the same, and/or when the difference between imaging times is sufficiently short. The imaging conditions include how the light strikes the object, the settings of the sensor 30, etc.

### Training

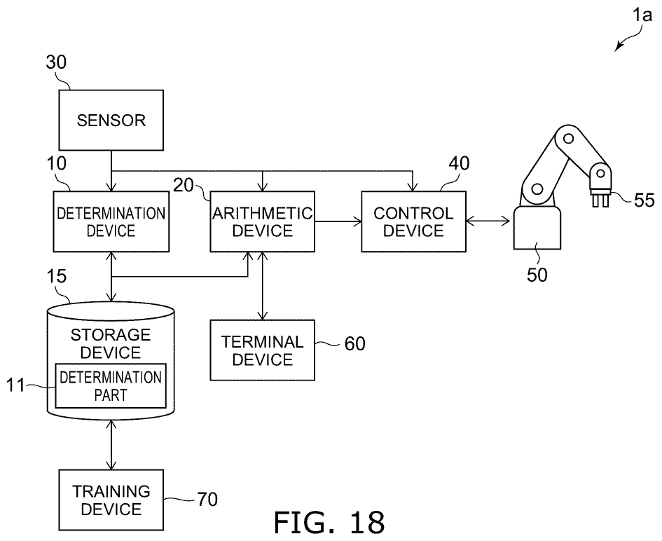

FIG. 18 is a schematic view showing a configuration of a processing system according to a modification of the embodiment.

Compared to the processing system 1, the processing system 1a shown in FIG. 18 further includes a training device 70. The training device 70 pre-trains the first and second models. The training device 70 stores the first and second models that are trained in the storage device 15.

The training device 70 also retrains the second model by using results obtained by the processing of the processing system 1a. When the third method is performed, the person designates, in the image, the position of the object, the gripping position, and the gripping angle. The image that is used, the designated position of the object, the designated gripping position, and the designated gripping angle are stored in the storage device 15. The training device 70 retrains the second model by using the image used in the third method as the input data, and by using the designated position of the object, the designated gripping position, and the designated gripping angle as the teaching data. As a result, the gripping success rate of the second model can be improved. Also, the determination part 11 may be retrained so that the object used to retrain the second model has a higher determination percentage of the second method. As a result, the determination frequency of the third method for the object used to retrain the second model can be reduced, and the transfer efficiency can be further increased.

The training device 70 may be provided separately from the determination device 10 and the arithmetic device 20, or the determination device 10 or the arithmetic device 20 may include the function of the training device 70.

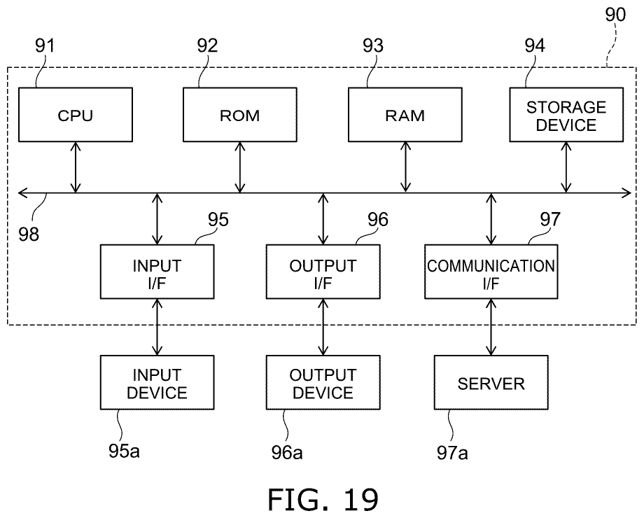

FIG. 19 is a schematic view illustrating a hardware configuration.

For example, a computer 90 (a processing device) shown in FIG. 19 is used as the determination device 10, the arithmetic device 20, or the control device 40. The computer 90 includes a CPU 91, ROM 92, RAM 93, a storage device 94, an input interface 95, an output interface 96, and a communication interface 97.

The ROM 92 stores programs controlling operations of the computer 90. The ROM 92 stores programs necessary for causing the computer 90 to realize the processing described above. The RAM 93 functions as a memory region into which the programs stored in the ROM 92 are loaded.

The CPU 91 includes a processing circuit. The CPU 91 uses the RAM 93 as work memory to execute the programs stored in at least one of the ROM 92 or the storage device 94. When executing the programs, the CPU 91 executes various processing by controlling configurations via a system bus 98.

The storage device 94 stores data necessary for executing the programs and/or data obtained by executing the programs.

The input interface (I/F) 95 can connect the computer 90 and an input device 95a. The input I/F 95 is, for example, a serial bus interface such as USB, etc. The CPU 91 can read various data from the input device 95a via the input I/F 95.

The output interface (I/F) 96 can connect the computer 90 and an output device 96a. The output I/F 96 is, for example, an image output interface such as Digital Visual Interface (DVI), High-Definition Multimedia Interface (HPMI (registered trademark)), etc. The CPU 91 can transmit data to the output device 96a via the output I/F 96 and cause the output device 96a to display an image.

The communication interface (I/F) 97 can connect the computer 90 and a server 97a outside the computer 90. The communication I/F 97 is, for example, a network card such as a LAN card, etc. The CPU 91 can read various data from the server 97a via the communication I/F 97.

The storage device 94 includes at least one selected from a hard disk drive (HDD) and a solid state drive (SSD). The input device 95a includes at least one selected from a mouse, a keyboard, a microphone (audio input), and a touchpad. The output device 96a includes at least one selected from a monitor, a projector, a printer, and a speaker. A device such as a touch panel that functions as both the input device 95a and the output device 96a may be used.

The processing performed by any of the determination device 10, the arithmetic device 20, or the control device 40 may be realized by one computer 90 or may be realized by collaboration of multiple computers 90. One computer 90 may function as two or more selected from the determination device 10, the arithmetic device 20, and the control device 40.

The processing of the various data described above may be recorded, as a program that can be executed by a computer, in a magnetic disk (a flexible disk, a hard disk, etc.), an optical disk (CD-ROM, CD-R, CD-RW, DVD-ROM, DVD+R, DVD+RW, etc.), semiconductor memory, or another non-transitory computer-readable storage medium.

For example, the information that is recorded in the recording medium can be read by a computer (or an embedded system). The recording format (the storage format) of the recording medium is arbitrary. For example, the computer reads a program from the recording medium and causes a CPU to execute the instructions recited in the program based on the program. In the computer, the acquisition (or the reading) of the program may be performed via a network.

Embodiments of the invention include the following features.

### Feature 1

A determination device, configured to:
acquire an image of an object to be gripped;
input the image to a determination part, the determination part including a first model, the first model being trained; and
obtain, from the determination part, an acquisition method of a gripping point at which a gripper is to grip the object,
according to the input of the image, the determination part outputting, as the acquisition method, one of
   a first method of calculating exterior shape data of the object based on the image and calculating the gripping point by using the exterior shape data,
   a second method of inputting the image to a second model and acquiring the gripping point output from the second model, the second model being trained, or
   a third method of acquiring the gripping point by the gripping point being designated.

### Feature 2

The determination device according to feature 1, in which
the determination part outputs the acquisition method and classifies a state of the object as one of normal without damage or abnormal with damage.

### Feature 3

The determination device according to feature 2, in which
the first model includes a neural network, and
the first model outputs the acquisition method and a classification result of the state of the object.

### Feature 4

A processing system, including:
the determination device according to any one of features 1 to 3; and
an arithmetic device configured to acquire the gripping point by using the acquisition method determined by the determination device.

### Feature 5

The processing system according to feature 4, further including:
a transfer device including the gripper; and
a control device moving the gripper to the gripping point obtained by the arithmetic device.

### Feature 6

The processing system according to feature 5, further including:
a terminal device connected with the arithmetic device via a network,
when the determination device determines the acquisition method to be the third method, the arithmetic device requesting the terminal device to designate the gripping point and receiving the gripping point designated by the terminal device.

### Feature 7

The processing system according to feature 6, in which
the terminal device displays the image and accepts a designation of the gripping point on the image.

### Feature 8

The processing system according to any one of features 4 to 7, further including:
a training device configured to train the second model,
the training device training the second model by using the image and the gripping point designated by the third method.

### Feature 9

A transfer system, including:
a transfer device including a gripper, the transfer device being configured to handle an object with the gripper; and
a determination device configured to
   acquire an image of an object,
   input the image to a determination part including a first model, the first model being trained, and
   obtain, from the determination part, an acquisition method of a gripping point at which the gripper is to grip the object,
according to the input of the image, the determination part outputting, as the acquisition method, one of
   a first method of calculating exterior shape data of the object based on the image and calculating the gripping point by using the exterior shape data,
   a second method of inputting the image to a second model and acquiring the gripping point output from the second model, the second model being trained, or
   a third method of acquiring the gripping point by the gripping point being designated.

### Feature 10

A determination method, including:
causing a computer to
   acquire an image of an object to be gripped,
   input the image to a determination part including a first model, the first model being trained, and
   acquire, from the determination part, an acquisition method of a gripping point at which a gripper is to grip the object,
according to the input of the image, the determination part outputting, as the acquisition method, one of
   a first method of calculating exterior shape data of the object based on the image and calculating the gripping point by using the exterior shape data,
   a second method of inputting the image to a second model and acquiring the gripping point output from the second model, the second model being trained, or
   a third method of acquiring the gripping point by the gripping point being designated.

### Feature 11

A program, when executed by the computer according to feature 10, causing the computer to perform the determination method according to feature 10.

### Feature 12

A storage medium, configured to store the program according to feature 11.

According to the embodiments above, a determination device, a processing system, a transfer system, a determination method, a program, and a storage medium are provided in which the transfer processing efficiency can be increased.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention. Moreover, above-mentioned embodiments can be combined mutually and can be carried out.

What is claimed is:

1. A determination device, configured to:
acquire an image of an object to be gripped;
input the image to a determination part, the determination part including a first model, the first model being trained; and
obtain, from the determination part, an acquisition method of a gripping point at which a gripper is to grip the object,
according to the input of the image, the determination part outputting, as the acquisition method, one of
a first method of calculating exterior shape data of the object based on the image and calculating the gripping point by using the exterior shape data,
a second method of inputting the image to a second model and acquiring the gripping point output from the second model, the second model being trained, or
a third method of acquiring the gripping point by the gripping point being designated.

2. The determination device according to claim 1, wherein
the determination part outputs the acquisition method and classifies a state of the object as one of normal without damage or abnormal with damage.

3. The determination device according to claim 2, wherein
the first model includes a neural network, and
the first model outputs the acquisition method and a classification result of the state of the object.

4. The determination device according to claim 1, wherein
the first model includes
an encoder configured to output a variable or a probability distribution according to input of the image, and
a clustering model configured to cluster the output from the encoder.

5. The determination device according to claim 1, wherein
the clustering model configured to cluster the output from the encoder into one of a first cluster corresponding to the first method, a second cluster corresponding to the second method, and a third cluster corresponding to the third method.

6. A processing system, comprising:
the determination device according to claim 1; and
an arithmetic device configured to acquire the gripping point by using the acquisition method determined by the determination device.

7. The processing system according to claim 6, further comprising:
a transfer device including the gripper; and
a control device moving the gripper to the gripping point obtained by the arithmetic device.

8. The processing system according to claim 7, further comprising:
a terminal device connected with the arithmetic device via a network,
when the determination device determines the acquisition method to be the third method, the arithmetic device requesting the terminal device to designate the gripping point and receiving the gripping point designated by the terminal device.

9. The processing system according to claim 8, wherein
the terminal device displays the image and accepts a designation of the gripping point on the image.

10. The processing system according to claim 6, further comprising:
a training device configured to train the second model,
the training device training the second model by using the image and the gripping point designated by the third method.

11. A transfer system, comprising:
a transfer device including a gripper, the transfer device being configured to handle an object with the gripper; and
a determination device configured to
acquire an image of an object,
input the image to a determination part including a first model, the first model being trained, and
obtain, from the determination part, an acquisition method of a gripping point at which the gripper is to grip the object,
according to the input of the image, the determination part outputting, as the acquisition method, one of
a first method of calculating exterior shape data of the object based on the image and calculating the gripping point by using the exterior shape data,
a second method of inputting the image to a second model and acquiring the gripping point output from the second model, the second model being trained, or
a third method of acquiring the gripping point by the gripping point being designated.

12. A determination method, comprising:
causing a computer to
acquire an image of an object to be gripped,
input the image to a determination part including a first model, the first model being trained, and
acquire, from the determination part, an acquisition method of a gripping point at which a gripper is to grip the object,
according to the input of the image, the determination part outputting, as the acquisition method, one of
a first method of calculating exterior shape data of the object based on the image and calculating the gripping point by using the exterior shape data,
a second method of inputting the image to a second model and acquiring the gripping point output from the second model, the second model being trained, or
a third method of acquiring the gripping point by the gripping point being designated.

13. The determination method according to claim 12, wherein
the first model includes
an encoder configured to output a variable or a probability distribution according to input of the image, and
a clustering model configured to cluster the output from the encoder.

14. The determination method according to claim 13, wherein
the clustering model configured to cluster the output from the encoder into one of a first cluster corresponding to the first method, a second cluster corresponding to the second method, and a third cluster corresponding to the third method.

15. A non-transitory computer-readable storage medium, configured to:
store a program,
the program, when executed by the computer according to claim 12, causing the computer to perform the determination method according to claim 12.
